(19) United States
(12) Patent Application Publication
(10) Pub. No.: US 2019/0275681 A1
(43) Pub. Date: Sep. 12, 2019

(54) TORQUE SENSOR DEVICE AND METHOD FOR DETECTING TORQUES

(71) Applicant: FRANKA EMIKA GmbH, Munich (DE)

(72) Inventors: Niklas Böhme, Munich (DE); Tim Rokahr, Munich (DE)

(73) Assignee: FRANKA EMIKA GmbH, Munich (DE)

(21) Appl. No.: 16/340,916

(22) PCT Filed: Oct. 16, 2017
(86) PCT No.: PCT/EP2017/076378

§ 371 Date: Apr. 10, 2019

(30) Foreign Application Priority Data
Oct. 17, 2016 (DE) 10 2016 012 324.9

(51) Int. Cl. B25J 13/08; G01L 3/14; G01L 5/22

(52) U.S. Cl. CPC B25J 13/085; G01L 5/226; G01L 3/1457

(57) ABSTRACT

The invention relates to a torque sensor device with a measuring flange, which is designed to cooperate with a movable component for detecting torques occurring on this component, and which has a flange outer ring and a flange inner ring, the flange outer ring and the flange inner ring are connected by at least two measuring spokes, which are designed to deform under the effect of a torque, the measuring spokes being designed such that they can be decoupled with respect to a force acting in the radial direction onto said measuring spokes. Furthermore, the invention relates to a manipulator for a robot which has at least one drive unit in one of its joints, at which such a torque sensor device is implemented.

The present invention relates to a torque sensor device as well as to a method for detecting torques by means of such a torque sensor device, in particular of torques occurring at or in a joint of a manipulator of a robot.

Robots, in particular of the lightweight construction, have an articulated arm or a manipulator, which is composed of a plurality of arm members or links connected via joints, the articulations or joints being actuated by means of corresponding drive units in order to selectively turn an arm member in relation to an arm member of the manipulator adjoining said arm member. Important components of these robots are torque sensors for detecting the torques which are caused by the movement of the links themselves or by externally acting forces. In most cases, these torque sensors are installed in or on all movable links of the robot, which allows for the compliant control of the manipulator.

Various systems for detecting torques are known from the prior art. A common method is the use of strain gauges as sensor elements which change their electrical resistance even with small deformations of components. As a rule, bridge circuits (so-called Wheatstone measuring bridges) are used for the evaluation, in which the temperature influences can be compensated, which is why measuring methods with strain gauges are particularly suitable for such precision measurements. For example, WO 2009/083111 A2 describes a torque sensor device with strain gauges as sensor elements, which are connected into two Wheatstone bridges for evaluation, in which the resistors of two strain gauges each are arranged at two different locations of a component being connected to the movable member and each are connected into a half-bridge, and in which two half-bridges each form a bridge circuit. A further bridge circuit is formed by the resistors of two further strain gauges which are arranged at two further different locations of the component. The torque values thus output are then compared with one another.

Moreover, it is known to use measuring flanges or similar devices which interact with a movable component for detecting torques occurring at or in this component. Such measuring flanges can be connected, for example, to an articulated arm robot with a joint of a drive unit or integrated into the same.

Torque sensor devices with measuring flanges are known, for example, from EP 0 575 634 B1 or DE 36 05 964 A1.

In principle, the above-mentioned systems and methods for torque detection in the prior art have the disadvantage that a deformation of the strain gauge, which can be caused, for example, by compressions of the strain gauge due to transverse forces, axial forces and bending moments on the measuring flange, can lead to various signals independently of the torque load to be detected, which signals are input as measurement errors into the signal evaluation, although there actually exists no error. In order to prevent such measurement inaccuracies and deviations in the signal evaluation, DE 10 2014 210 379 A1 proposes, for example, a torque sensor device with a measuring flange, which has four uniformly distributed measuring spokes, in which two strain gauges are each arranged, when seen in the direction of rotation of the measuring flange, at two opposing sides of the measurement spokes. The strain gauges are each switched or connected in at least two bridge circuits.

However, such a torque sensor device entails a complex evaluation electronics due to the number of strain gauges and is also not suitable for drive units in articulated arm robots in which certain radial forces can act as a result of the robot design.

For example, a manipulator is described in German patent application No. 10 2015 012 960.0, in which the articulated arms are formed by two half-shell-like housing structures which, during assembly, clamp the drive units in the joints between members/links of the articulated arm. Under certain tolerance conditions, thereby permanently and radially acting forces can arise after assembly, which are guided into the measuring flange and thus into the radially oriented measuring spokes, thus distorting the deformations of the measuring spokes to be absorbed, i.e. detected by the sensor elements.

Furthermore, forces acting on the measuring flange can occur, which for example are caused by the leverage effect which is produced by the dead weight of the manipulator, whereby especially the load has the greatest influence with a fully extended, stretched-out manipulator. Also, the transmission or gear mechanisms that are used in the drive units, which provide the necessary reduction from an electric drive motor, can exert corresponding axially acting forces on the measuring flange, particularly in the vicinity of the axis of the links.

In the course of a highly accurate measurement of torques and, furthermore, to achieve error-free compliance control of a manipulator, in particular of a robot of lightweight construction, it is necessary to eliminate or reduce as far as possible the negative factors influencing the manipulator's control. This applies, in particular, to lightweight construction manipulators, as described, for example, in German patent application No. 10 2015 012 960.0.

In the course of a highly accurate measurement of torques and, furthermore, to achieve error-free compliance control of a manipulator, in particular a robot of lightweight construction, it is necessary to eliminate or reduce as far as possible the negative factors influencing the manipulator's control. This applies, in particular, to lightweight construction manipulators, as described, for example, in German patent application No. 10 2015 012 960.0.

It is therefore the object of the present invention to provide a torque sensor device and a corresponding method for detecting torques in which the above-mentioned disadvantages can be avoided and with which a more accurate and less error-prone detection of torques is possible. A further object is to provide a correspondingly improved manipulator or articulated arm for a corresponding robot and such a robot.

These objects are achieved according to the invention by the torque sensor devices according to claim 1 or claim 2, by a method for detecting of torques according to claim 18 or 19 and by a manipulator according to claim 20 as well as a robot according to claim 21.

The torque sensor device as well as the method for detecting torques according to the invention for detecting torques is fundamentally directed to all possible applications in which torques occurring at a movable component are to be detected. These are particularly, but not exclusively, suitable for applications in robotics, such as, for example, in connection with articulated arms of lightweight construction robots, and in particular for applications in manipulators with multi-part housing structures as mentioned above.

In a first embodiment, the invention proposes a torque sensor device which has a measuring flange which is designed and configured to cooperate with a movable component for detecting torques occurring on or at this component, the measuring flange having a flange outer ring and a flange inner ring, and the flange outer ring and the flange outer ring are connected by at least two measuring spokes which are designed and configured to deform under the effect of a torque. The measuring spokes are designed and configured or have such means that they are decoupled with respect to a force acting in the radial direction onto these measuring spokes.

Thereby, decoupling is to be understood as meaning that a force acting essentially in the radial direction onto the measuring, as can occur, for example, during the assembly of housing structures of the arm members under certain circumstances, can not be introduced into the measuring spokes, so that their deformation during the torque detection is unaffected by such interfering forces.

In a second embodiment, the invention proposes a torque sensor device which has a measuring flange which is configured to cooperate with a movable component for detecting torques occurring at this component, the measuring flange having a flange outer ring and a flange inner ring, and the flange outer ring and the flange outer ring are connected by at least two measuring spokes which are designed to deform under the effect of a torque. The measuring spokes are designed or have such means that they engage the flange outer ring in a direction deviating from the radial direction.

For the decoupling or for the realization of a connection of the measuring spoke in relation to the flange outer ring, which is eccentric to the radial direction, the torque sensor device is designed in a preferred embodiment according to the invention such that the measuring spokes have a segment extending radially from the flange inner ring and in which at least one sensor element for the detection of the deformation is arranged, wherein following this segment for the sensor element the measuring spokes spread or split into at least two connecting struts towards the flange outer ring. This means that these connecting struts engage the flange outer ring at points which are not positioned onto the radial extension of the remaining measuring spoke, i.e. of the segment for the at least one sensor element.

Preferably, the connecting struts are arranged mirror-symmetrically with respect to the axis of symmetry formed by the segment for the sensor element and form an obtuse angle with one another.

The connecting struts thus arranged are compliant to forces which act perpendicularly from the outside, i.e. radially onto the segment of the sensor element. Such radial forces are therefore not introduced, or only to a small extent, into the segment of the measuring spoke, whereby the latter is decoupled radially outwards in relation to the flange outer ring. Forces which are introduced into the segment for the sensor element from the left or right are supported and accommodated by the connecting struts so that these forces can bypass the sensor element.

A further decoupling of the measuring spokes against radial forces is achieved in that at least one supporting spoke is arranged between two measuring spokes which extends in the radial direction between the flange inner ring and the flange outer ring, the supporting spoke being arranged equidistantly from the two measuring spokes and comprises preferably a substantially equal wall thickness as the connecting struts. The supporting spoke delimits, in each case, with the connecting struts being adjacent in the direction of rotation to it, a recess, the recesses being arranged mirror-symmetrically with respect to the supporting spoke.

In the case of forces directly acting in the radial direction at the level of the segment for the sensor element as well as laterally thereto, the special arrangement of the measurement spokes with the connecting struts on the one hand and of the supporting spokes on the other ensures that the majority of the force transmission from the outside to the inside takes place via the supporting spokes. For a torque acting on the sensor element, the segment remains free of interfering forces and the sensor element is exclusively sensitive to the torque-induced deformation.

The material of this segment is deformed when the section of the measuring spoke for the sensor element is loaded, may it be by the torque to be detected or possibly also by disturbing, interfering forces. As a result, the surface of the material is not merely simply compressed or stretched, but a curvature is also produced which results from the pressure and the finite length of the measuring spoke or the segment for the sensor element. However, such a curvature would again have a negative effect on the measuring behavior of the sensor element.

In order to circumvent such an influence on the measuring result, the invention proposes, in a further preferred embodiment, that the segment for the sensor element has a smaller dimension in the axial direction of the measuring flange compared to the dimension of the measuring flange; in particular preferably the dimension of the segment for the sensor element should be half of the dimension of the measuring flange thereby forming a pocket. In this way, it is possible to arrange the sensor element exactly in the middle of the segment, as viewed in the axial direction of the measuring flange. At this point, a curvature would be, if it appears at all, as small as possible and would have the slightest influence on the detection of the deformation.

The measuring flange is preferably cast and/or milled as a one-piece component, for example made of aluminum, whereby the pockets can subsequently be milled into the segments of the measuring spokes.

In a further preferred embodiment according to the invention, the at least one sensor element is arranged on the axial surface of the segment of the measuring spoke. The sensor element is arranged over the surface of the segment in a planar manner so that it faces the end of a measuring and evaluation electronics on a printed circuit board which is connected to the measuring flange in a corresponding manner.

Preferably, the sensor element is a strain gauge and in particular preferably a strain gauge rosette or a multiple shear strain gauge arrangement. Such strain gauges are present in foil structures and can be adhesively bonded to the surfaces of the pockets in a simple manner, so as to be deformable together with the measuring spoke. It is also possible to attach and fix the strain gauges to the surfaces by means of bonding. Strain gauges are suitable for the high-precision measurement of torques in connection with the bridge circuitry to be explained in the following, since strain gauges already change their resistance value with a low expansion or compression.

Alternatively, however, it is also possible that the at least one sensor element is integrated in the axial surface of the segment of the measuring spoke. For example, corresponding measuring structures can be applied to the surface of the segments by inserting or evaporation depositing these measuring structures, for example, by lasering, scraping, etching or the like. However, in principle, more complex sensor units with an integrated amplifier and/or evaluation electronics can also be used.

Irrespective of the choice of the sensor element, it is provided according to the invention that the sensor electronics is always arranged on the printed circuit board at a point which is at the same distance from the center of the sensor element as the contact surfaces of the sensor element for the connection to the sensor electronics, which thus are arranged on the same radius. In this way, it is ensured that the connection can not adversely affect the measuring result, for example by tensile or compressive load, since this location deforms to the same extent as the sensor element, as a result of which the sensor electronics always remains stationary with respect to the sensor element.

Independently of the choice of the sensor elements, in a further preferred embodiment according to the invention, four measuring spokes are provided with segments for two sensor elements each, the measuring spokes being arranged equidistantly in the direction of rotation, and in which the sensor elements of segments radially opposing each other are connected in a bridge circuit.

Alternatively, it is also possible that, in the case of four measurement spokes with segments for two sensor elements each, the sensor elements of two segments being adjacent in the direction of rotation are each connected in a bridge circuit.

These bridge circuits are preferably configured as Wheatstone bridge circuits, which consist of two parallel voltage dividers, so that a voltage divider forms a half-bridge in each case. The voltage dividers, in turn, are in each case formed by two resistors arranged in series. The sensor elements, in particular the strain gauges, form corresponding variable resistances in the bridge circuits, the resistance changes of adjacent sensor elements having an opposite effect on the bridge voltage. Correspondingly, the resistance changes of opposing sensor elements have the same effect on the bridge voltage.

In both cases, the sensor elements of a segment are then connected in each case in a half-bridge which forms a voltage divider within the full bridge.

In this context, therefore the invention also relates to a method for detecting torques by means of a torque sensor device with a measuring flange, which is designed to interact with a movable component for detecting torques occurring on this component, and which has a flange outer ring and a flange inner ring, wherein the flange outer ring and the flange inner ring are connected by four measuring spokes being equidistantly arranged in the direction of rotation of the measuring flange, which measuring spokes are designed to deform under the effect of a torque and which have a segment which extends radially from the flange inner ring and in which two sensor elements for detecting the deformation are arranged, the method comprising:
detecting a deformation of the measuring spokes by means of the sensor elements, and
evaluation of the signals generated by the sensor elements by means of two bridge circuits, wherein the sensor elements of radially opposite segments each are connected in one bridge circuit and the sensor elements of a segment are each connected in a half-bridge of the bridge circuit.

In another embodiment, the invention suggests a method for detecting torque by means of a torque sensor device with a measuring flange, which is designed to cooperate with a movable component for detecting torques occurring on this component, and which has a flange outer ring and a flange inner ring, wherein the flange outer ring and the flange inner ring are connected by four measuring spokes being equidistantly arranged in the direction of rotation of the measuring flange, which measuring spokes are designed to deform under the effect of a torque and which have a segment which extends radially from the flange inner ring and in which two sensor elements for detecting the deformation are arranged, the method comprising:
detecting a deformation of the measuring spokes by means of the sensor elements, and
evaluation of the signals generated by the sensor elements by means of two bridge circuits, wherein the sensor elements of segments being adjacent in the direction of rotation are each connected in one bridge circuit and the sensor elements of a segment are each connected in a half-bridge of the bridge circuit.

In addition, the invention also relates to a manipulator of a robot which has a plurality of links connected via joints, wherein at least one link movable by means of a drive rotatably connects a first link of the manipulator to a second link of the manipulator, and in which the joint comprises at least on torque sensor device according to one of the above-described embodiments for detecting torques occurring at or in the joint, as well as to a robot which has at least one such manipulator.

Further features and advantages of the invention will emerge from the description of the exemplary embodiments illustrated with reference to the appended drawings, in which

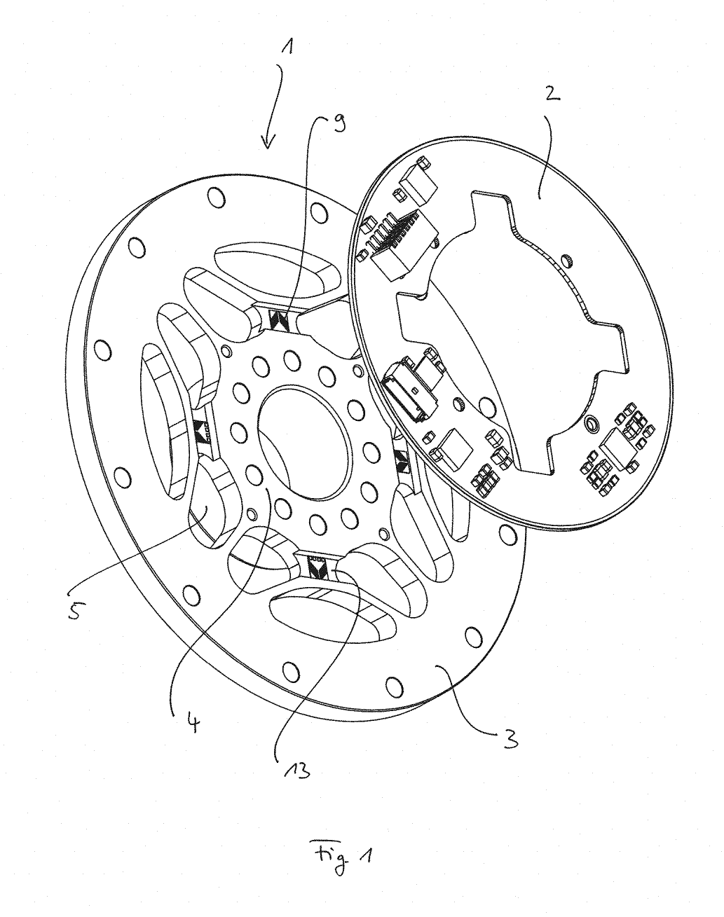

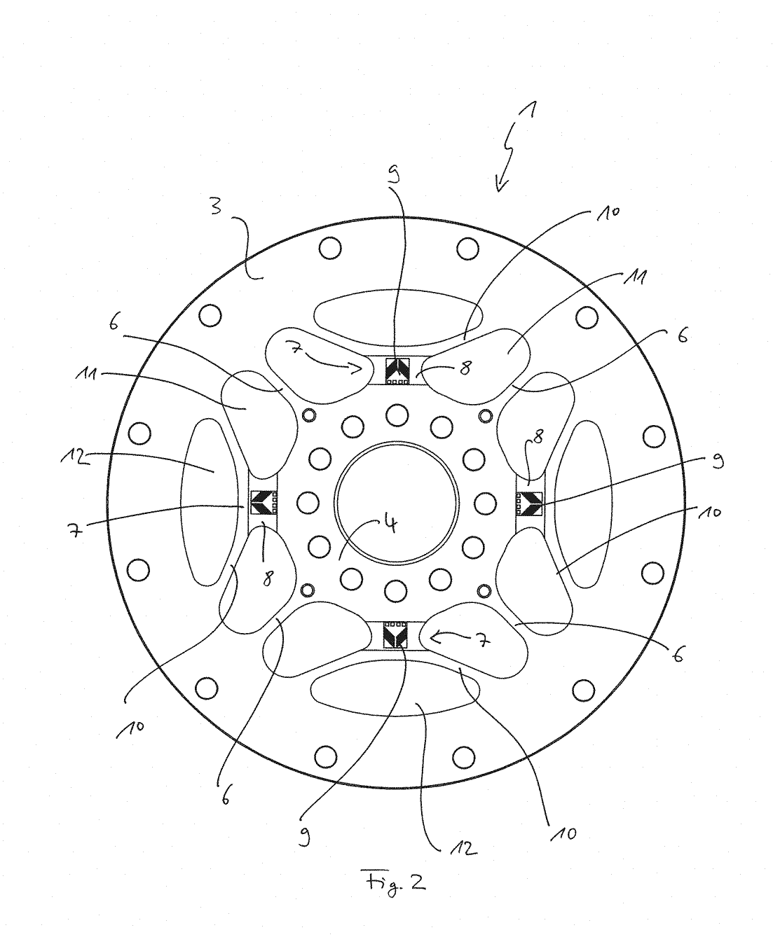

FIG. 1 is an exploded perspective view of a torque sensor device according to the invention;

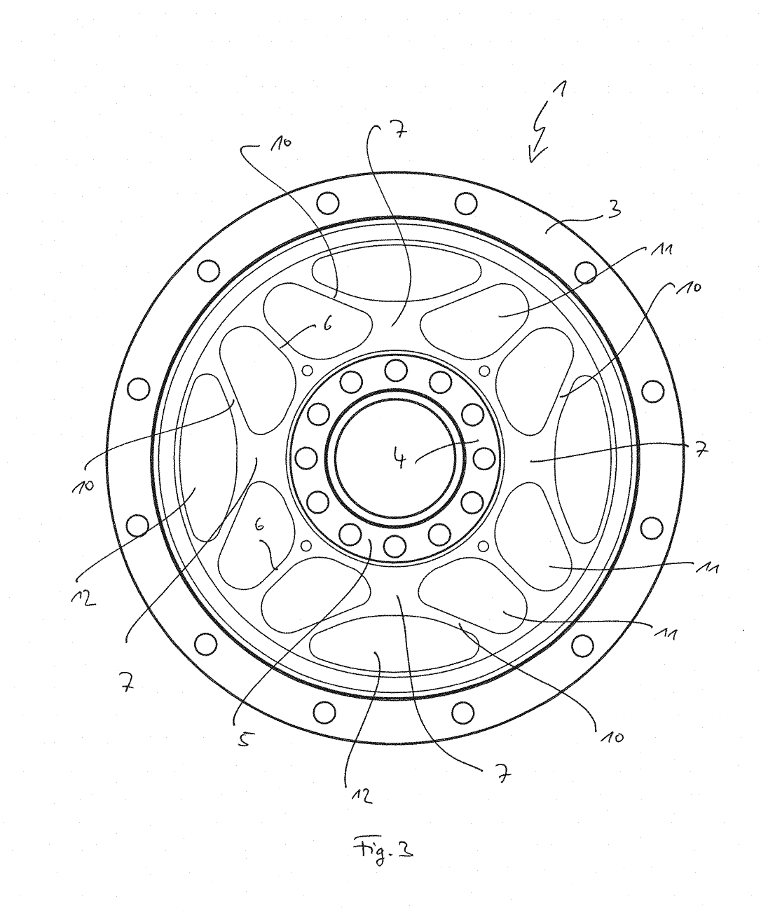

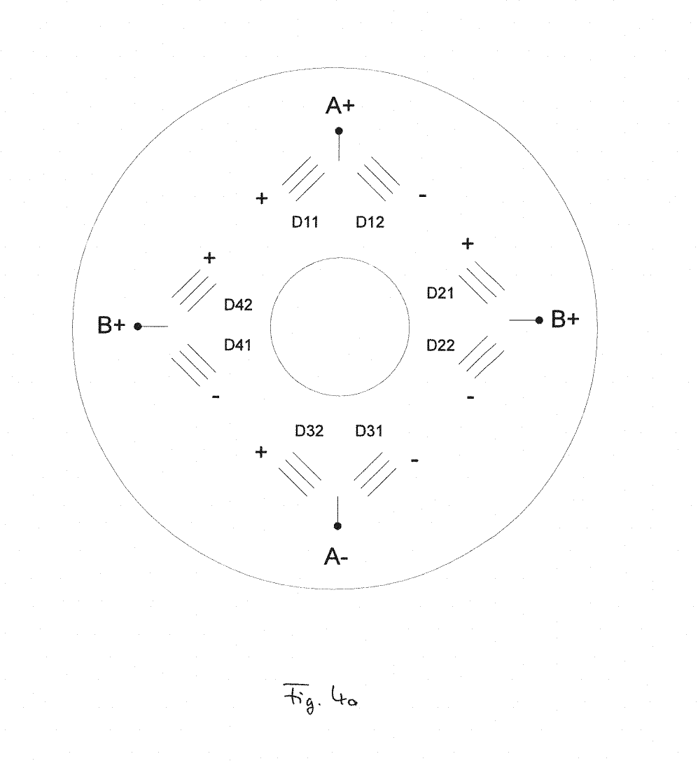

FIG. 2 is a plan view of a sensor-side surface of a measuring flange;

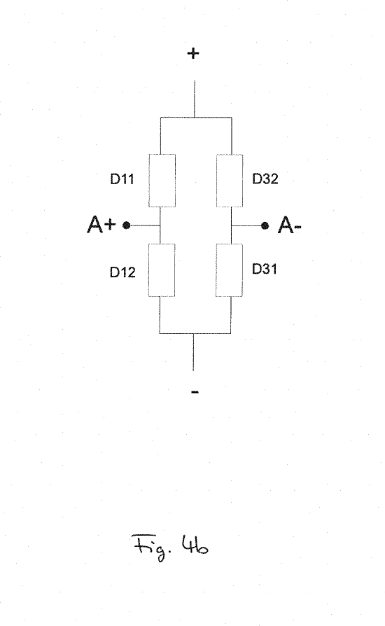

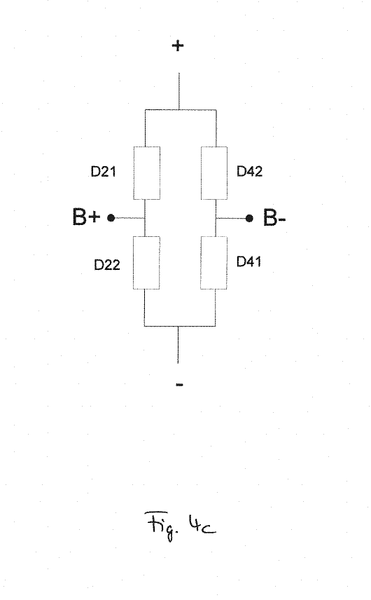

FIG. 3 is a plan view of a drive-side surface of this measuring flange;

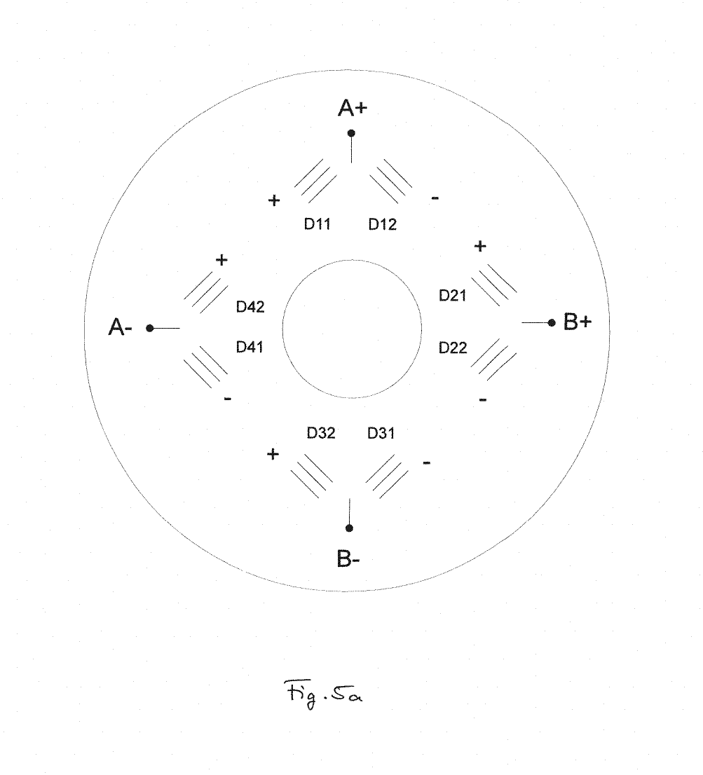

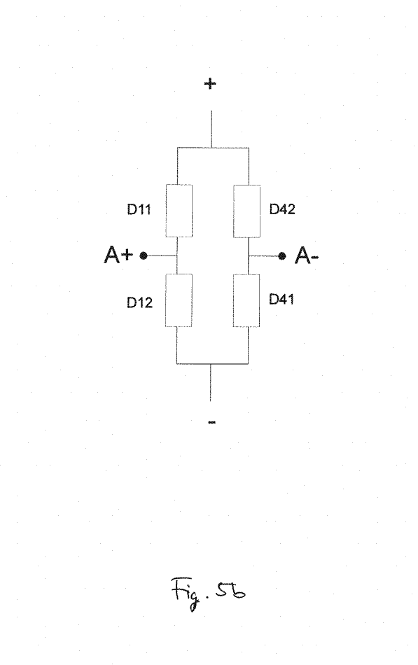

FIG. 4a shows schematically a first switching arrangement according to the invention;

FIG. 4b shows a first bridge circuit with reference to the first switching arrangement;

FIG. 4c shows a second bridge circuit with reference to the first switching arrangement;

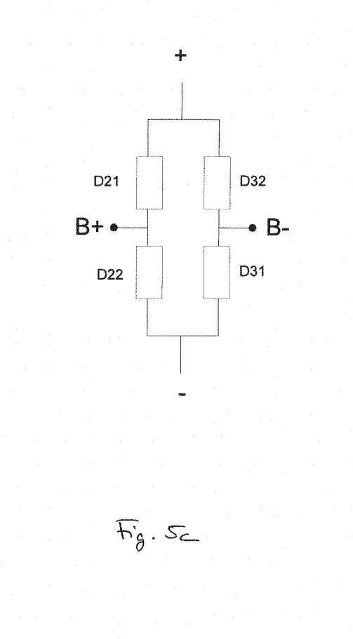

FIG. 5a schematically shows a second switching arrangement according to the invention;

FIG. 5b shows a first bridge circuit with respect to the second switching arrangement; and

FIG. 5c shows a second bridge circuit with reference to the second switching arrangement.

FIG. 1 shows by way of example a torque sensor device according to the invention in an exploded view.

A printed circuit board 2, which carries the sensor and evaluation electronics, is located opposite a measuring flange 1, which serves as the non-rotatable connection to a movable component of a drive unit (not shown) for a joint of a manipulator of a robot. The printed circuit board 2 is non-rotatably connected to the measuring flange 1.

FIG. 2 shows a plan view of the sensor-side surface of the measuring flange 1, whereas FIG. 3 reproduces the opposite surface of this measuring flange 1 facing the drive unit.

The measuring flange 1 is preferably milled as a one-piece aluminum component and has a defined geometric structure according to the invention.

For this purpose, the measuring flange 1 consists of a flange outer ring 3 and a flange inner ring 4. A hub 5 extends from the flange inner ring 4 in the axial direction to the drive unit.

A plurality of connecting elements is provided between the flange inner ring 4 and the flange outer ring 3. For example, the measuring flange 1 has, at a uniform distance of 90°, four supporting spokes 6 which extend in the radial direction between the flange inner ring 4 and the flange outer ring 3.

Four measuring spokes 7 are provided between the supporting spokes 6, each at an equal distance, that is to say offset by 90°.

According to the invention, the measuring spokes 7 each consist of a segment 8 which extends in the radial direction from the flange inner ring 4 and serves to receive a sensor element 9, which is designed here as a multiple shear strain gauge (strain gauge).

To the flange outer ring 3, the segment 8 of the measuring spoke 7 is divided into two connecting struts 10, which are arranged mirror-symmetrically to the segment 8 and together form an obtuse angle, preferably in a range of approximately 120-150°. The connecting struts 10 are connected to the flange outer ring 3 in an orientation deviating from the radial direction.

In this way, the segment 8 with the strain gauge 9 can be decoupled from any force acting in the radial direction.

Radial forces are then transmitted mainly through the supporting spokes 6 between the flange outer ring 3 and the flange inner ring 4.

The connecting struts 10 and the supporting spokes 6 have the same wall thickness and in each case jointly delimit recesses 11, which are then distributed symmetrically and uniformly in the circumferential direction of the measuring flange 1. The connecting struts 10 and the flange outer ring 3 also include corresponding recesses 12.

The distribution and the geometry of these recesses 11 and 12, in particular also the internal radii thereof, are selected in such a way that all disturbing, interfering forces on the segments 8 of the measuring spokes 7 are avoided or at least largely attenuated so that the segments 8 are subjected exclusively to the torques-induced deformations which is to be detected by means of the strain gauges 9.

In order to avoid the negative influences of curvatures on the surface of the segments 8 on the measuring result, as can be seen from FIG. 1, the segments 8 are provided with a reduced materials thickness in the axial direction in comparison to the material thickness of the measuring flange 1, thereby forming pockets 13 which serve to receive the strain gauges 9.

FIGS. 4a to 4c show a first embodiment of the connection or circuitry which is used in connection with the measuring flange 1 according to the invention and the strain gauges 9 arranged thereon in the pockets 13.

In the case of four measuring spokes 7 each having four sensor elements 9, two measuring spokes 7 each of which are located opposite one another, the strain gauges 9 are interconnected or switched via exactly two full bridges, with two half bridges which are located opposite each other.

By such an arrangement, “squeezing” within a full bridge, i. e. the orientation of a deformation of the segments 8, which orientation differs on both sides with respect to the axis of the measuring flange 1, is already largely compensated since the quarter bridges are each excited in such a way that the signal detected by the sensor electronics in sum remains the same.

The shear strain gauges 9 each have two strain gauges arrangements being offset at right angles to one another, the apex point is being oriented in the radial direction, namely D11 and D12, D21 and D22, D31 and D32, as well as D41 and D42. In FIGS. 4b, c and 5b, c, these designations correspond to the changing resistances in the voltage dividers.

A first full bridge (FIG. 4b) is formed by a bridge circuit between radially opposing strain gauges 9, having D11 and D12 as a first half bridge, and D32 and D31 as a second half bridge. In an analogous manner, a second full-bridge (FIG. 4c) is formed as bridge circuitry between D21 and D22 as a first half-bridge and between D42 and D41 as a second half-bridge. The first and the second full bridge are offset relative to one another by 90°, analogous to the measuring spokes 7.

As already mentioned, the problem with manipulators of articulated arm robots is that, particularly in the extended, stretched-out state of the manipulator, tilting moments can be exerted on the measuring flange 1, which can influence the deformation of the measuring spokes 7 and thus the measuring result.

This “tilting” or “clamping” of the measuring flange 1 can be compensated for by the selected electrical circuitry with the two full bridges, as explained above, since by the offset by 90° of the second to the first full bridge the same forces, which influence the first full bridge, exactly oppositely effect the second full bridge, which has the same circuitry structure. It is thus simply sufficient to form the mean value from both full bridges, so that the influence of the tilting moments can thereby be compensated.

FIGS. 5a to c show a further possible connection or circuitry of the strain gauges 9.

Here, D11 and D12 as a first half-bridge are combined with D42 and D41 as a second half-bridge into a first full-bridge (FIG. 5b). The second full bridge (FIG. 5c) is formed by D21 and D22 as a first half bridge and by D32 and D31 as a second half bridge.

In order to minimize the influence of the gear of the drive unit, which exerts a pressure on the measuring flange 1 near the axis in the axial direction, the symmetry of the above-mentioned circuitries is suitable since all the strain gauges 9 are thereby evenly loaded, which means that in the sum no deflection in the total signal occurs, since either all the strain gauges 9 are stretched, resulting in a resistance increase, or all strain gauges 9 are compressed, which leads to a reduction in the resistance, the extent of the stretching or compression being always uniform, since all strain gauges 9 are at an equal angle to the applied pressure force of the gear.

1. A torque sensor device comprising a measuring flange configured to cooperate with a movable component for detecting torques occurring on said component and having a flange outer ring and a flange inner ring, the flange outer ring and the flange inner ring are connected by at least two measuring spokes, which are configured to deform under the influence of a torque, wherein the measuring spokes are configured in such a way that said measuring spokes are decoupled with respect to a force acting on said measuring spokes in a radial direction.

2. A torque sensor device comprising a measuring flange configured to cooperate with a movable component for detecting torques occurring on said component and having a flange outer ring and a flange inner ring, said flange outer ring and said flange inner ring are connected by at least two measuring spokes, which are configured to deform under the influence of a torque, wherein the measuring spokes engage the flange outer ring in a direction deviating from the radial direction.

3. A torque sensor device according to claim 1, in which the measuring spokes have a segment extending radially from the flange inner ring and having arranged at least one sensor element for detecting the deformation, and in which following the segment for the sensor element said measuring spokes spread out into at least two connecting struts towards the flange outer ring.

4. A torque sensor device according to claim 3, in which the connecting struts are arranged mirror-symmetrically to the axis of symmetry formed by the segment for the sensor element.

5. A torque sensor device according to claim 3, in which the connecting struts form an obtuse angle with one another.

6. A torque sensor device according to claim 3, in which the segment for the sensor element has a smaller dimension in the axial direction of the measuring flange compared to the dimension of the measuring flange.

7. A torque sensor device according to claim 6, in which the dimension of the segment for the sensor element corresponds to half of the dimension of the measuring flange.

8. A torque sensor device according to claim 3, in which at least one supporting spoke is arranged between the two measuring spokes and extends in the radial direction between the flange inner ring and the flange outer ring.

9. A torque sensor device according to claim 8, in which the supporting spoke is arranged equidistantly from the two measuring spokes.

10. A torque sensor device according to claim 8, in which the wall thickness of the supporting spoke essentially corresponds to the wall thickness of the connecting struts.

11. A torque sensor device according to claim 8, in which the support spoke delimit a recess with the connecting struts adjoining in the direction of rotation, respectively, the recesses being arranged mirror-symmetrically with respect to the support spoke.

12. A torque sensor device according to claim 3, in which the at least one sensor element is arranged on the axial surface of the segment of the measuring spoke.

13. A torque sensor device according to claim 3, in which the at least one sensor element is integrated on the axial surface of the segment of the measuring spoke.

14. A torque sensor device according to claim 12, in which four measuring spokes are provided with segments for two sensor elements each, the measuring spokes being arranged equidistantly with each other in the direction of rotation, and in which the sensor elements of radially opposing segments are each connected in a bridge circuit.

15. A torque sensor device according to claim 12, in which four measuring spokes are provided with segments for two sensor elements each, the measuring spokes being arranged equidistantly with each other in the direction of rotation, and in which the sensor elements of two segments being adjacent in the direction of rotation are each connected in a bridge circuit.

16. A torque sensor device according to claim 14, in which the sensor elements of a segments are each connected in a half-bridge.

17. A torque sensor device according to claim 12, in which the sensor element is configured as a multiple shear strain gauge arrangement with at least two strain gauges.

18. Method for detecting torques by means of a torque sensor device with a measuring flange, which is configured to interact with a movable component for detecting torques occurring on this component, and which has a flange outer ring and a flange inner ring, wherein the flange outer ring and the flange inner ring are connected by four measuring spokes being equidistantly arranged in the direction of rotation of the measuring flange, which measuring spokes are configured to deform under the effect of a torque and which have a segment which extends radially from the flange inner ring and in which two sensor elements for detecting the deformation are arranged, the method comprising:
detecting a deformation of the measuring spokes by means of the sensor elements, and
evaluation of the signals generated by the sensor elements by means of two bridge circuits, wherein the sensor elements of radially opposite segments each are connected in one bridge circuit and the sensor elements of one segment are each connected in a half-bridge of the bridge circuit.

19. Method for detecting torque by means of a torque sensor device with a measuring flange, which is configured to cooperate with a movable component for detecting torques occurring on this component, and which has a flange outer ring and a flange inner ring, wherein the flange outer ring and the flange inner ring are connected by four measuring spokes being equidistantly arranged in the direction of rotation of the measuring flange, which measuring spokes are configured to deform under the effect of a torque and which have a segment which extends radially from the flange inner ring and in which two sensor elements for detecting the deformation are arranged, the method comprising:
detecting a deformation of the measuring spokes by means of the sensor elements, and
evaluation of the signals generated by the sensor elements by means of two bridge circuits, wherein the sensor elements of segments being adjacent in the direction of rotation are each connected in one bridge circuit and the sensor elements of one segment are each connected in a half-bridge of the bridge circuit.

20. A manipulator of a robot which has a plurality of arm links being connected via joints, wherein at least one joint being movable by means of a drive is rotatably connecting a first link of the manipulator to a second link of the manipulator, wherein the joint comprises at least a torque sensor device according to claim 1 for detecting torques occurring at or in the joint.

21. A robot comprising at least one manipulator according to claim 20.
